(19) United States
(12) Patent Application Publication
(10) Pub. No.: US 2003/0016590 A1
(43) Pub. Date: Jan. 23, 2003

(54) Timepiece module with bi-stable display

(76) Inventors: Donald R. Brewer, Dallas, TX (US); William David Jansen, San Diego, CA (US)

Correspondence Address: CARSTENS YEE & CAHOON, LLP, P O BOX 802334, DALLAS, TX, 75380

(21) Appl. No.: 09/909,344

(22) Filed: Jul. 19, 2001

(51) Int. Cl. G04C 19/00

(52) U.S. Cl. 368/82

(57) ABSTRACT

The bi-stability of electrophoretic and gyricon display technologies allows a display to maintain its image for a period of time without the driving electronics activated. The watch takes advantage of this attribute by being powered once a minute. This minimizes power consumption while not decreasing the functionality of the watch. Unlike LCDs, every segment of an electrophoretic display can be addressed by a conductive matrix, even segments encircled by other addressable segments. This allows the watch to have a visual alarm wherein every segment is inverted at a predetermined rate. In other words, time could be displayed in dark numbers against a light background. The image would then be inverted so that the light numbers would be displayed on a dark background. The display can be purposefully forced to all light or all dark until the users queries the watch for the time. This provides an aesthetic effect until the user actually needs to see the time.

### BACKGROUND OF THE INVENTION

1. Technical Field of the Invention

The present invention relates generally to a watch, also called a timepiece module, or other device having a display, and specifically to the use of an electrophoretic or gyricon display that is both reflective and flexible. The invention entails the use of the bi-stable nature of such displays and the electronics required for its implementation.

2. Description of Prior Art

Watches come in a variety of shapes and sizes. The watch display is usually either mechanical with at least two hands that sweep around a marked dial or a liquid crystal display. In either case, one common constraint for prior art watches is the rigidity of the display. It is common for the display to have a metal casing and either a glass or hard plastic crystal.

FIG. 1A illustrates a standard prior art watch 10. The watch has a thick case 12 that contains the time keeping mechanism. The case can be anywhere from a few millimeters thick to well over a centimeter. The case can be made of metal or a hard plastic; but in either case, it must be rigid to protect the time keeping mechanism. Likewise, FIG. 1B illustrates a generic digital watch 20. The watch also has a display. In many instances the display is a liquid crystal display (LCD) 22. An LCD display provides several advantages including generally low power requirements. The LCD is usually employed in a reflective display mode. In other words, selected segments of the LCD display are biased to either a black or a gray state. The gray segments are approximately 15-25% reflective; so at most the light segment areas are only one sixth to one quarter of the incident light producing grayish color, while the much darker segments are used in the shape of numbers or letters. Ambient or supplemental light reflects off of the segments and the user can determine the time or date. LCD displays must typically also incorporate a hard crystal display cover when utilized in watches to keep the watch watertight.

A need exists for a flexible display for watches. A flexible display would allow for a number of significant advancements in the design and mechanical implementation of watches. Despite much effort directed to developing highly-flexible, reflective display media, there are relatively few examples of displays formed on semi-flexible substrates, and these examples have found only moderate success. For example, plastic-based liquid crystal displays, including twisted nematic (TN), supertwisted nematic (STN), polymer dispersed liquid crystal (PDLC), and bistable cholesteric liquid crystals have been developed. Nevertheless, problems remain with liquid crystal alignment in TN and STN displays, cholesteric displays are sensitive to changes in their cell gap, and local stress can cause changes in the scattering or absorbance of PDLC and cholesteric films. As such, only moderate flexibility can be achieved with these displays.

Emissive electroluminescent films and organic light emitting diode films can be deposited on flexible substrates to create flexible displays. However, these devices require continuous power consumption for operation, and thus are not practical for many applications.

The concept of electronic ink, or e-ink, is disclosed in U.S. Pat. No. 6,118,426, owned by E-Ink Corp. of Cambridge Mass. An encapsulated electrophoretic display can be constructed so that the optical state of the display is stable for some length of time. When the display has two states that are stable in this manner, the display is said to be bistable. If more than two states of the display are stable, then the display can be said to be multistable. The term bistable indicates a display in which any optical state remains fixed once the addressing voltage is removed. The definition of a bistable state depends on the application for the display. A slowly-decaying optical state can be effectively bistable if the optical state is substantially unchanged over the required viewing time. For example, in a display that is updated every few minutes, a display image that is stable for hours or days is effectively bistable for that application. The term bistable also indicates a display with an optical state sufficiently long-lived as to be effectively bistable for the application in mind. Alternatively, it is possible to construct encapsulated electrophoretic displays in which the image decays quickly once the addressing voltage to the display is removed (i.e., the display is not bistable or multistable). Whether or not an encapsulated electrophoretic display is bistable, and its degree of bistability, can be controlled through appropriate chemical modification of the electrophoretic particles, the suspending fluid, the capsule, and binder materials.

An encapsulated electrophoretic display may take many forms. The display may comprise capsules dispersed in a binder. The capsules may be of any size or shape. The capsules may, for example, be spherical and may have diameters in the millimeter range or the micron range, but is preferably from ten to a few hundred microns. Particles may be encapsulated in the capsules. The particles may be two or more different types of particles. The particles may be colored, luminescent, light-absorbing or transparent, for example. The particles may include neat pigments, dyed (laked) pigments or pigment/polymer composites, for example. The display may further comprise a suspending fluid in which the particles are dispersed.

Referring to FIG. 2A, a display 30 is created by printing a first conductive coating 32 on a substrate 34, printing an electronic ink 36 on the first conductive coating 32, and printing a second conductive coating 38 on the electronic ink 36. Conductive coatings 32, 38 may be Indium Tin Oxide (ITO) or some other suitable conductive material. The conductive layers 32, 38 may be applied from a vaporous phase, by electrolytic reaction, or deposition from a dispersed state such as spray droplets or dispersions in liquids. Conductive coatings 32, 38 do not need to be the same conductive material. For example, the substrate 34 is a polyester sheet having a thickness of about 4 mil, and the first conductive coating 32 is a transparent conductive coating such as ITO or a transparent polyaniline. The second conductive coating 38 may be an opaque conductive coating, such as a patterned graphite layer. Alternatively, the second conductive coating 38 can be polymeric. The polymer can be intrinsically conductive or can be a polymer carrier with a metal conductor such as a silver-doped polyester or a silver-doped vinyl resin. Conductive polymers suitable for use as the second electrode include, for example, polyaniline, polypyrole, polythiophene, polyphenylenevinylene, and their derivatives. These organic materials can be colloidally dispersed or dissolved in a suitable solvent before coating.

The display 30 can also be created by printing a first conductive coating 32 on a first substrate 34, printing an electronic ink 36 on the first conductive coating 32, printing a second conductive coating 38 on a second substrate 34′ (not shown), and configuring the substrates 34, 34′ such that the second conductive coating 38 is in electrical communication with the electronic ink 36.

The electronic ink 36 comprises a plurality of capsules. The capsules, for example, may have an average diameter on the order of about 100 microns. Capsules this small allow significant bending of the display substrate without permanent deformation or rupture of the capsules themselves. The optical appearance of the encapsulated medium itself is more or less unaffected by the curvature of these capsules. FIG. 2B illustrates one example of the display media 40. A microcapsule or cell 42, filled with a plurality of metal sol 46 and a clear fluid 44. Metal sol 46 are particles which are smaller than a wavelength of light. In one detailed embodiment, the metal sol 46 comprises gold sol. When an electric field is applied across the microcapsule or cell 42, sol particles 46 agglomerate and scatter light. When the applied electric field is reduced to below a certain level, Brownian motion causes the sol particles 46 to redistribute, and the display media 40 appears clear from the clear fluid 44.

One of the benefits of using printing methods to fabricate displays is eliminating the need for vacuum-sputtered ITO by using coatable conductive materials. The replacement of vacuum-sputtered ITO with a printed conductive coating is beneficial in several ways. The printed conductor can be coated thinly, allowing for high optical transmission and low first-surface reflection. For example, total transmission can range from about 80% to about 95%. In addition, the printed conductive coating is significantly less expensive than vacuum-sputtered ITO. Another advantage of the encapsulated electrophoretic display medium is that relatively poor conductors can be used as lead lines to address a display element.

The flexible, inexpensive display described above is useful in numerous applications. For example, these, flexible displays can be used in applications where paper is currently the display medium of choice. Alternatively, the displays can be made into disposable displays. The displays can be tightly or bent. In other embodiments, the displays can be placed onto or incorporated into highly flexible plastic substrates, fabric, or paper. Since the displays can be rolled and bent without sustaining damage, they form large-area displays that are highly portable. Since these displays can be printed on plastics they can be lightweight. In addition, the printable, encapsulated electrophoretic display can maintain the other desirable features of electrophoretic displays, including high reflectance, bistability, and low power consumption.

One alternative to the E-ink electrophoretic displays is a gyricon display. Gyricon displays are based on a different principal, namely the use of sphere having a white side and a dark side. This technology has been largely developed by Xerox, as demonstrated by its U.S. Pat. No. 5,808,783. In the '783 patent a gyricon or twisting-ball display is disclosed having having reflectance characteristics comparing favorably with those of white paper. The display is based on a material made up of optically anisotropic particles, such as bichromal balls, disposed in a substrate having a surface. The particles situated closest to the substrate surface form substantially a single layer. Each particle in the layer has a center point, no particle in the layer being disposed entirely behind the center point of any nearest neighboring particle in the layer with respect to the substrate surface. Each particle in the layer has a projected area with respect to the substrate surface. Particles of the set are sufficiently closely packed with respect to one another in the layer that the union of their projected areas exceeds two-thirds of the area of the substrate surface. A rotatable disposition of each particle is achievable while the particle is thus disposed in the substrate; for example, the particles can already be rotatable in the substrate, or can be rendered rotatable in the substrate by a nondestructive operation. In particular, the particles can be situated in an elastomer substrate that is expanded by application of a fluid thereto so as to render the particles rotatable therein. A particle, when in its rotatable disposition, is not attached to the substrate. A reflective-mode display apparatus can be constructed from a piece of the material together with a mechanism (e.g., addressing electrodes) for facilitating rotation of at least one of the particles.

FIG. 2C provides a more detailed side view of a gyricon display 50 of the invention in a specific embodiment. In display 50, bichromal balls 52 are placed as close to one another as possible in a monolayer in elastomer substrate 54. Substrate 54 is swelled by a dielectric fluid (not shown) creating cavities 56 in which the balls 52 are free to rotate. The cavities 56 are made as small as possible with respect to balls 52, so that the balls nearly fill the cavities. Also, cavities 52 are placed as close to one another as possible, so that the cavity walls are as thin as possible. Preferably, balls 52 are of uniform diameter and situated at a uniform distance from upper surface 58.

Balls 52 are electrically dipolar in the presence of the dielectric fluid and so are subject to rotation upon application of an electric field, as by matrix-addressable electrodes 60, 62. The electrode 60 closest to upper surface 58 is preferably transparent.

An observer sees an image formed by the black and white pattern of the balls 52 as rotated to expose their black or white hemispheres to the upper surface 58 of substrate 54

A monolayer gyricon display according to the invention has advantages in addition to improved reflectance. The operating voltage needed for such a display is less than the voltage needed for a conventional thick gyricon display. This is because the rotation of gyricon balls under the influence of an electric field depends on the field strength. Electric field is the derivative of voltage with respect to distance (for example, in the simple case of a parallel plate capacitor, E=V/d). Thus a given electric field strength can be achieved with a lower applied voltage, other things being equal, by reducing the distance over which the voltage is applied. Accordingly, by using the thinnest configuration possible, which is a monolayer, the operating voltage of the gyricon display is minimized. A lower operating voltage has many advantages, including lower power consumption, less expensive drive electronics, and increased user safety.

Despite the promise of e-ink and gyricon displays, neither technology has achieved any level of commercial implementation. A need exists for translating these technologies into useful displays in the field of watches. Specifically, a need exists for translating the memory retention features of electrophoretic displays into a power saving feature for watches. A need also exists for a watch that can take advantage of the image inversion features of these types of displays.

### SUMMARY OF THE INVENTION

The present invention addresses many of the shortcomings of the prior art watch technology. Specifically, a watch that embodies the present invention is highly flexible and uses addressable reflective display technology such as electronic ink or gyricons. This allows a watch display that can be highly flexible.

One aspect of this invention is to utilize the memory retention capability, or bistability, of these display technologies that allows a display to maintain its image for a period of time without the driving electronics activated. In other words, the display could be powered once a minute, which is the standard time-keeping unit. The battery power can be saved if the driving electronics can be switched off for fifty-nine seconds of each minute. In a basic digital watch it is only necessary to display hours and minutes. The display material can be developed with targeted memory retention so the segments can be turned on, and retain the same quality image for at least one minute, or at most require intermittent applications of voltage within a minute to maintain same quality image

In one embodiment, the display can also be inverted at a predetermined rate to create a visual alarm. In other words, time could be displayed in dark numbers against a light background. The image would then be inverted so that the light numbers would be displayed on a dark background. Unlike LCDs, electrophoretic displays allow the individual addressing of virtually every segment of a display. This same feature could be user controlled so that the user could effectively change the appearance of their watch on command.

In another embodiment, the display can be purposefully forced to all light or all dark until the users queries the watch for the time. This provides an aesthetic effect until the user actually needs to see the time.

A control unit, or MCU, provides basic time-keeping functions. The MCU drives an LCD driver that allows one to drive a display with very high voltages. For example, an electronic ink display may require 18 volts or more. In contrast, an LCD display might require 2 to 3 volts. If a conventional 3-volt battery is used, step-up circuitry will be needed to convert the battery's output to the appropriate voltage level. In one embodiment, a set of cascading diodes could be used in the step-up circuitry.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1A is a mechanical watch with an analog display;

FIG. 1B is a digital watch with a digital display;

FIGS. 2A and 2B illustrate an example of an electronic ink display;

FIG. 2C illustrates a gyricon display;

FIG. 3 illustrates a flexible watch display that embodies the present invention;

FIG. 4 illustrates a flexible, and reflective watch display that has an approximately one minute image retention;

FIGS. 5A and 5B show a visual alarm function wherein the image can be repeatedly inversed;

FIGS. 6A and 6B show a watch wherein the display can be uniformly shaded or colored until a time keeping function is selected;

FIG. 7 illustrates a watch having an alternative power source, namely a solar cell; and

FIG. 8 is a block diagram showing the electronics needed to power and control an electrophoretic display used in a watch.

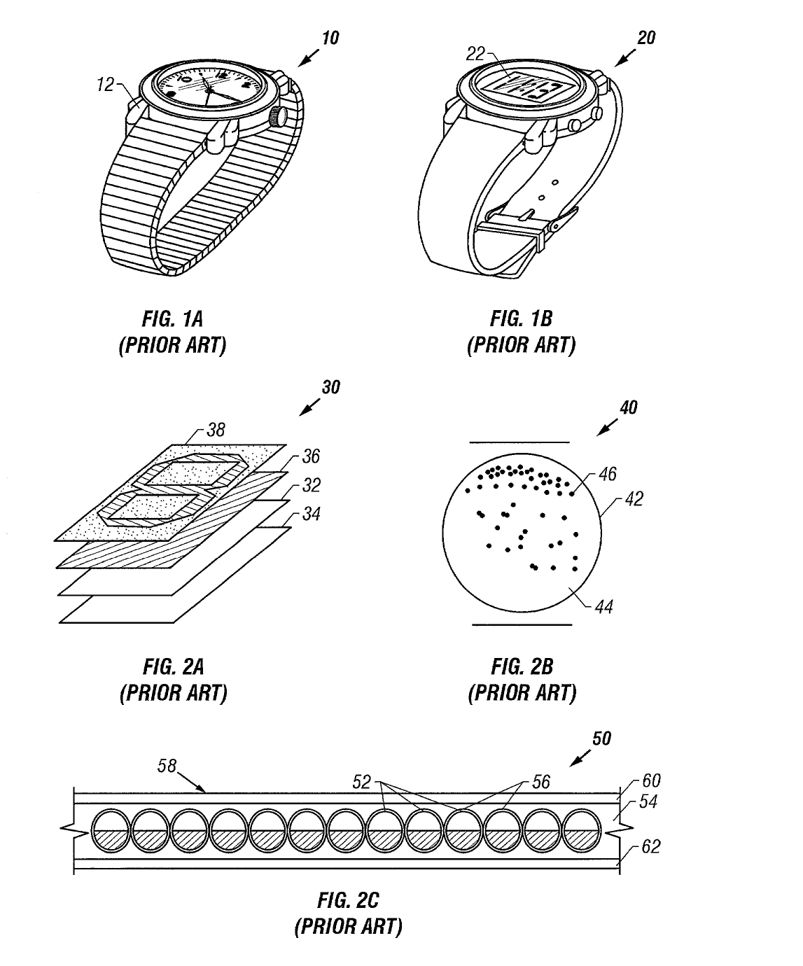

### DETAILED DESCRIPTION OF THE DRAWINGS

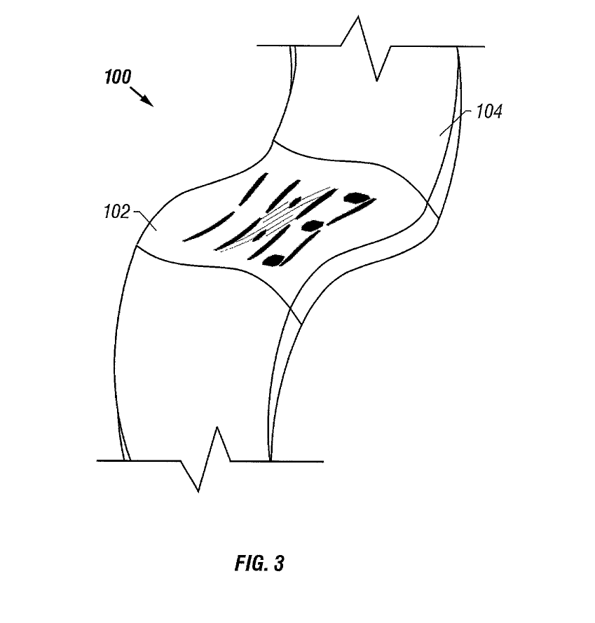

FIG. 3 is one embodiment of the present invention, namely a thin and flexible watch. This flexibility is created through the use of an electrophoretic display such as a electronic ink or a gyricon display. The display 102 can have a plurality of addressable segments shaped to allow the formation of letters, numbers and other graphical shapes. For example, as illustrated, the segments can be shaped to show the time. A timer unit coupled to the display tracks the time and generates a signal that is then translated into the addresses of the segments to be biased. A conductive matrix layer receives this signal and biases the display accordingly, in this case to show the time 11:13. A band 104 can be incorporated to allow the watch to be worn around the user's wrist.

As discussed above, an interesting attribute of an electrophoretic or gyricon display is memory retention, or bi-stability. In other words, the display can hold an image for a fixed amount of time even when a biasing electric field has been removed. In contrast, an LCD display must be powered constantly, or at least with refresh rate of 60 Hz, since they have a decay time of approximately 100-150 milliseconds to return to “off” state orientation after an applied voltage has been removed. Image retention is particularly useful when implementing a display into a watch. For example, a watch that only shows hours and minutes would only need to be updated once every minute. This allows the biasing field to be switched off for that minute, thereby saving battery power. Specifically, this invention relates to a timepiece module with a timer that includes a controller that powers a bi-stable display less than 60 times a second. The timer also can be broadly defined to include a driver for translating the timer's output into a signal for actuating the bi-stable display. For example, the controller could power the display no more than once, twice, or thrice a minute, or even ten times a minute.

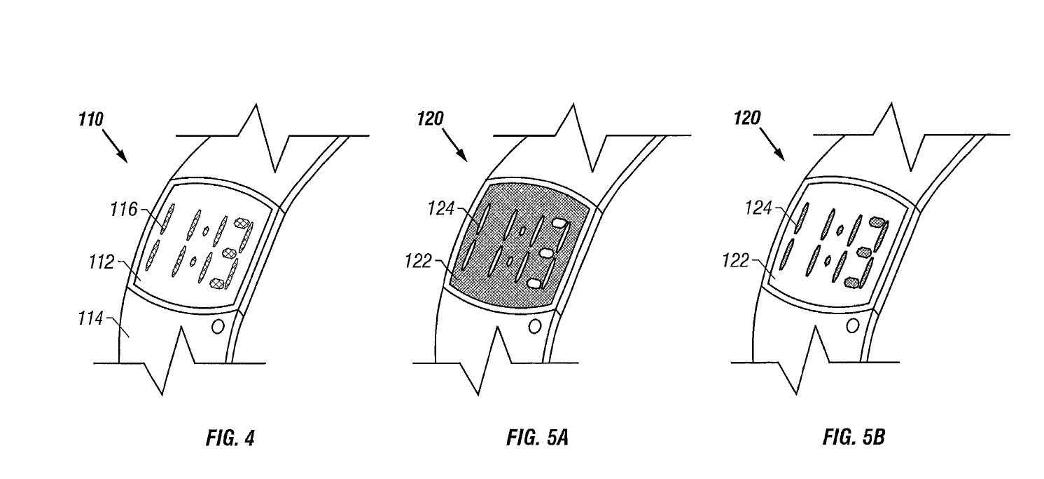

FIG. 4 illustrates a flexible, and reflective watch 110 having a display 112 and a band 114. With electronic ink, encapsulated particles begin to disperse after a set amount of time when a biasing field is removed. This results in a dark image segment 116 on a light background. Once a biasing field is reapplied, then the image is refreshed and possible updated.

FIGS. 5A and 5B show a visual alarm function wherein the image can be repeatedly inversed. A watch 120 is shown wherein the time is displayed as light numerals 124 on a dark background 122, often referred to as a negative display mode. After a predetermined amount of time, the image is inversed so that the numbers 124 are dark on a light background 122, referred to as positive display mode. Unlike LCDs, every segment of an electrophoretic display can be addressed by a conductive matrix. Thus, even enclosed segments, such as the space within the loop of the number nine can be inverted. The image can invert at any predetermined rate until the user selects a stop command, such as by pressing a controller 126. The flashing effect of the image should draw the attention of the wearer. Further, by eliminating the need for a speaker unit, the electronics of the watch are simplified and power consumption reduced further. This feature could also allow the user to press a controller 126 and dynamically change the appearance of the display for aesthetic purposes in everyday use.

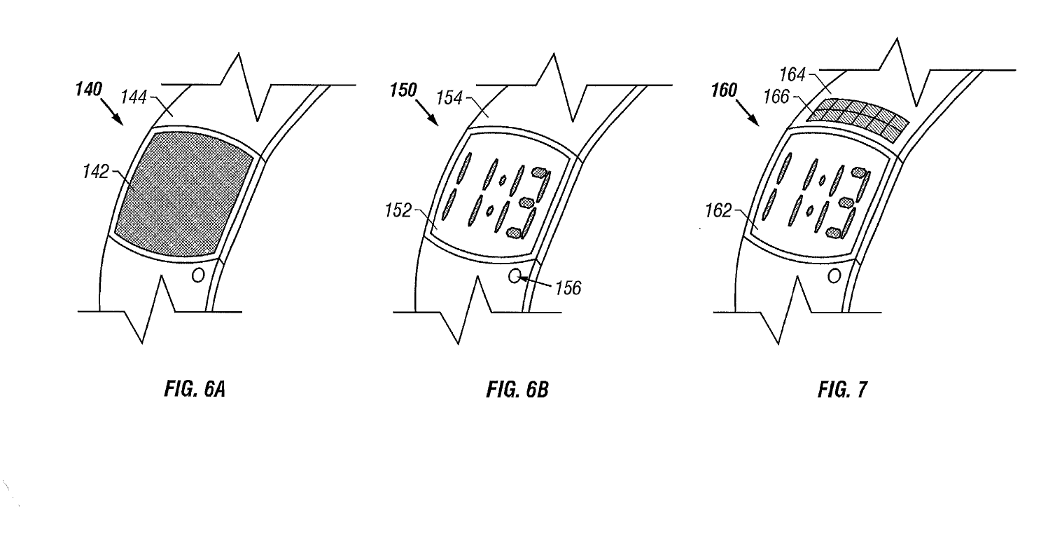

FIGS. 6A and 6B show a watch 140 wherein the display can be uniformly shaded or colored until a time keeping function is selected. In other words, the watch can be placed into a sleep mode. From a fashion viewpoint, the display in sleep mode could match the same color as the band. Thus, if red colored pigments are used in the encapsulated display medium, then a red band could be matched with it. Of course, almost any combination of mixing and matching is possible. When the user is ready to see the time displayed, a command button 146 is pressed.

A watch can be driven by various power sources other than a typical 3 volt battery. For example, FIG. 7 illustrates a watch 160 having an alternative power source, namely a solar cell 166. The solar cell could be placed adjacent to the display 162 on the band 164. Other power sources could include motion converters or even heat converters.

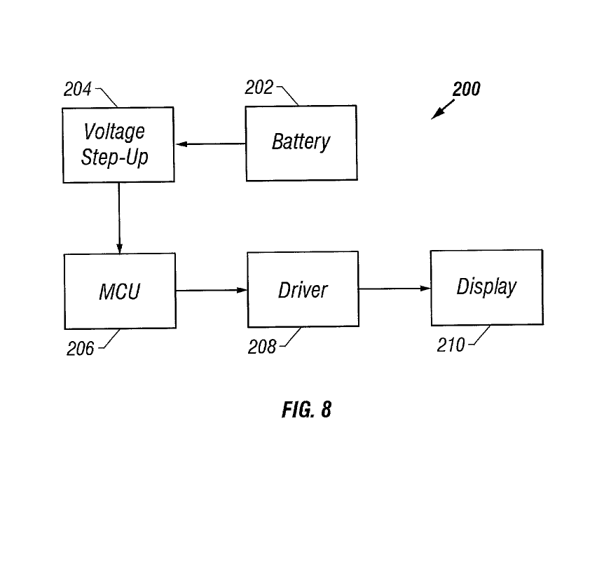

FIG. 8 is a block diagram 200 showing the electronics needed to power and control an electrophoretic display 210 used in a watch. While both e-ink and gyricon display technologies have very low power consumption, both still require very high voltages to drive the segments. For example, it would not be unusual for either display technology to require between 15 to 32 volts. Yet, a typical lithium coin cell battery will only supply 3 volts. A step-up circuit 204 could include a series of cascading diodes. A control unit 206 would handle the basic time keeping functions required for the watches operation. The control unit can also be referred to as a timer or an MCU. Finally, a display driver 208 is needed to translate the output of the control unit into commands to the conductive matrix of the display. For example, an Epson 1743 driver could work with an electrophoretic display. Another alternative is to use SUPERTEX driver chip for the voltage conversion and driving components.

In the preferred embodiment of this invention the bi-stable reflective display will be designed to allow for image retention for a minute with no visible degradation of image quality before the reapplication of the voltage, and change of the display when a minute passes. It should be recognized that in some cases the display may not be able to have image retention of one minute, and therefore would require the reapplication of the voltage to selected segments to retain the image during the minute until the display needs to be changed.

It is understood that other modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. A timepiece module comprising:
(a) a timer having (i) a driver; (ii) a controller; and (iii) an output; and
(b) a bi-stable display coupled to the timer output; wherein the controller switches power to the display less than 60 times a minute.

2. The timepiece module of claim 1 wherein said display is powered no more than once per minute.

3. The timepiece module of claim 1 wherein said display is powered no more than twice a minute.

4. The timepiece module of claim 1 wherein said display is powered no more than three times a minute.

5. The timepiece module of claim 1 wherein said display is powered no more than ten times a minute.

6. The timepiece module of claim 1 wherein said bi-stable display is an electrophoretic display.

7. The time piece module of claim 1 wherein said bi-stable display is a gyricon display.

8. The timepiece module of claim 1 wherein said bi-stable display is flexible.

9. The timepiece module of claim 1 wherein said bi-stable display is invertable.

10. The timepiece module of claim 1 wherein said display comprises a plurality of addressable segments.

11. The timepiece module of claim 9 wherein said invertable display can display a dark segment on a light background.

12. The timepiece module of claim 9 comprises a driver that can invert the display to display a light segment on a dark background.

13. The timepiece module of claim 9 wherein the controller inverts the display at a predetermined rate.

14. The timepiece module of claim 9 wherein a user can selectively invert the display.

15. The timepiece module of claim 1 further comprises a voltage source coupled to the timer.

16. The timepiece module of claim 15 wherein said voltage source comprises a battery.

17. The timepiece module of claim 15 wherein said voltage source comprises a solar cell.

18. The timepiece module of claim 15 wherein said voltage source comprises a mechanical source.

19. The timepiece module of claim 15 wherein said voltage source is a thermal source.

20. The timepiece module of claim 1 further comprises a light source adjacent to the bi-stable display, wherein said display is reflective and wherein said light source illuminates the display.

21. The timepiece module of claim 20 wherein said light source is an LED.

22. The timepiece module of claim 20 wherein said light source is an EL.

23. The timepiece module of claim 1 wherein said bi-stable display is bi-chromatic.

24. The timepiece module of claim 1 wherein said bi-stable display is polychromatic.

25. The timepiece module of claim 1 wherein said time further comprises a voltage step-up circuit.

26. A timepiece module comprising:
(a) a timer having (i) a driver; (ii) a controller; and (iii) an output; and
(b) a bi-stable display coupled to the timer output; wherein the controller switches power to the display less than 60 times a minute.
(c) light source adjacent to the bi-stable display, wherein said display is reflective and wherein said light source illuminates the display.

27. The timepiece module of claim 26 wherein said light source is an LED.

28. The timepiece module of claim 26 wherein said light source is an EL.

29. The timepiece module of claim 26 wherein said display is an electrophoretic display.

30. The timepiece module of claim 26 wherein said display is a gyricon display.

31. The timepiece module of claim 26 wherein said b-stable display is optimized to maintain a state for no less than one minute.

32. The timepiece module of claim 26 wherein said timer includes a voltage step-up circuit comprising a series of cascading diodes.

33. A timepiece module comprising:
(a) a timer having (i) a driver; (ii) a controller; and (iii) an output; and
(b) a bi-stable display having an invertable display, and coupled to the timer output; wherein the controller switches power to the display less than 60 times a minute, and wherein said timer can have an alarm that triggers the inversion of the display.

34. The timepiece module of claim 33 wherein said display is invertable between a first state and a second state.

35. The timepiece module of claim 33 wherein said invertable display can display a dark segment on a light background.

36. The watch of claim 33 wherein the driver inverts the display at a predetermined rate.
